(19) United States
(12) Patent Application Publication
(10) Pub. No.: US 2009/0284176 A1
(43) Pub. Date: Nov. 19, 2009

(54) INTELLIGENT ILLUMNIATION SOURCE PARTICULARLY FOR MACHINE VISION SYSTEMS

(76) Inventor: Robert S. Blenis, JR., Roswell, GA (US)

Correspondence Address: NELSON MULLINS RILEY & SCARBOROUGH, LLP, 1320 MAIN STREET, 17TH FLOOR, COLUMBIA, SC, 29201, US

(21) Appl. No.: 12/425,137

(22) Filed: Apr. 16, 2009

Related U.S. Application Data
(60) Provisional application No. 61/124,423, filed on Apr. 16, 2008.

(51) Int. Cl. H05B 37/02

(52) U.S. Cl. 315/294

(57) ABSTRACT

An illumination apparatus for use with a machine vision camera comprises at least one light source, preferably one or more LEDs, and control circuitry. The control circuitry is operative to receive an illumination command signal and selectively cause application of power to the light source in response thereto. The circuitry includes an electronic switch connected in circuit with the light source. Override circuitry is connected to control operation of the electronic switch so as to cause flow of current through the light source upon receipt of the illumination command signal in a variable manner so as to limit power dissipation.

### PRIORITY CLAIM

This application claims the benefit of provisional application Ser. No. 61/124,423, filed Apr. 16, 2008, which is relied upon and incorporated herein by reference in its entirety.

### BACKGROUND OF THE INVENTION

The present invention generally relates to camera illumination systems. More particularly, the invention relates to a light emitting diode (LED) light source for use with machine vision systems.

Machine vision generally relates to the process of using computer systems to visually inspect a process or product. Typical applications of machine vision could include the counting of objects on a conveyor belt, the reading of serial numbers or the inspection of manufactured components. By using computer technology to perform the inspection, errors associated with human inspection can be reduced or eliminated. Also, machine vision allows for higher inspection speeds and, through the use of magnification devices, may allow for the inspection or viewing of extremely small components or devices.

Intense illumination is often necessary for thorough inspection or measurement by the machine vision system. Typically, a xenon flash tube or other high intensity light source is used to provide the necessary lighting. Some systems utilize halogen or fluorescent lighting. The illumination techniques known in the art, however, may have undesired flash-to-flash variation. In some instances, the variation is caused by a fluctuating power source. Such variation can make inspection difficult due to overexposure or underexposure of the image by the inspection camera. Furthermore, in some instances, the lighting source may become damaged due to excess power dissipated through the circuit. If the lighting source is damaged, the functionality of the machine vision system becomes impaired.

Thus, a lighting source that delivers consistent, uniform light intensity in the presence of a fluctuating power source is needed. Furthermore, it is also desirable to provide circuit monitoring to assess the power dissipated by the illumination circuitry and react accordingly in order prevent damage to the light source.

### SUMMARY OF THE INVENTION

The present invention provides apparatus and methods to control an illumination source used with a machine vision system or the like. In a preferred embodiment, light emitting diodes (LEDs) are used to provide high-powered strobed lighting. The LEDs illuminate the subject being inspected by the machine vision system. As discussed herein, embodiments of the present invention are preferably adapted to control and protect the LEDs and associated circuitry from damage due to excess current and power dissipation.

The illumination apparatus may be configured as a stand alone unit. In other embodiments, the illumination apparatus may be connected to a camera or incorporated into a camera. In either case, the apparatus provides the necessary illumination so that inspection can be performed by the camera and the associated electronics.

The use of LEDs is generally desirable due to their consistent illumination qualities and relatively long lives. If too much current is used to drive the LEDs, however, they may burn out or the lifespan may be reduced. When used to provide strobe lighting, such as in a machine vision system, the LEDs are illuminated with high intensity for a short period of time.

The camera associated with the machine vision system preferably controls whether the LED, or array of LEDs, is illuminated. In some embodiments the LEDs will remain “on,” or illuminated, until the camera control system instructs them to turn off. In accordance with the present invention, the apparatus preferably includes circuitry that monitors the total power dissipated through the LEDs. If a power threshold is exceeded, the circuitry will preferably switch to a pulse width modulation (PWM) driving technique in order to limit the total power. By monitoring the power, and taking measures to limit the power dissipation if it gets too high, components of the circuitry may be protected from damage or failure.

Depending on system requirements, the machine vision control system will request different light intensities, or outputs, from the LEDs. In order to achieve these variations, the LEDs are driven typically for different lengths of time. For instance, in some embodiments, the LEDs may be driven for either 10 ms, 15 ms or 30 ms, depending upon the illumination needs of the camera.

Circuitry of the illumination apparatus may accept at least two inputs from the machine vision camera—one being an active high input and the other being an active low input. These inputs allow for various types of industrial equipment (sinking and sourcing) to interface with the illumination circuit. Additionally, in some embodiments, the illumination apparatus will have a user indicator, such as a LED, to indicate the presence of an error condition. For instance, if the power dissipated through the circuit exceeds a certain threshold, that user indicator may be illuminated.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying drawings, in which:

FIGS. 1 and 2 are block diagrams of the major functional components (five total) that may be utilized in an illumination apparatus in accordance with the present invention;

FIGS. 3-8 are electrical schematics of various components that may be utilized in an illumination apparatus as shown in FIGS. 1 and 2;

FIG. 9 is a diagram of LED placement in a preferred embodiment;

FIG. 10 shows the LED lighting board mounted inside a camera, without the lens, filter and lid;

FIG. 11 shows the LED lighting board in the camera case, with a lens (hidden under filter), filter (black, round piece in the middle), and lid/top cover in place to keep extraneous material such as dirt out of the camera; and

FIG. 12 is a flow chart showing exemplary methodology in accordance with the present invention.

Repeat use of reference characters in the present specification and drawings is intended to represent same or analogous features or elements of the invention.

### DETAILED DESCRIPTION OF PREFERRED EMBODIMENTS

It is to be understood by one of ordinary skill in the art that the present discussion is a description of exemplary embodiments only and is not intended as limiting the broader aspects of the present invention, which broader aspects are embodied in the exemplary constructions.

In accordance with the present invention, circuitry is preferably provided having an “AND” logic gate that receives a user input signal and a supervisory control signal as inputs. In some embodiments, the supervisory control signal will be generated by a microprocessor monitoring the power dissipation level of the circuit and LEDs and the user input signal will be delivered by the camera. A metal-oxide-semiconductor field-effect transistor (MOSFET), or other appropriate switching element, may be controlled by the output of the “AND” logic gate. This electronic switch preferably opens or closes the circuit delivering power to one or more LEDs. In the preferred embodiment, multiple LEDs are assembled into at least one array, or bank, of LEDs, with a MOSFET switching on and off the current to the banks of LEDs.

In the preferred embodiment, each bank of LEDs may have a constant source driver, such as a voltage regulator, to provide a constant current source to the bank of LEDs. Additionally, in the preferred embodiment, a supervisor microprocessor is utilized to measure the average “on” time for LEDs over a varying time window. Through this measurement, the microprocessor (or other appropriate control circuit) may determine if a power threshold is being exceeded.

During operation, when the user input signal (preferably from an associated camera) and supervisory control signal are both “high,” the “AND” gate preferably provides a control signal to the electronic switch associated with the LED banks. The control signal is also preferably delivered to the microprocessor to enable a timer. The microprocessor then preferably monitors the time to measure the cumulative time the electronic switch is “on” and delivering power to the LEDs during a sliding time window. The longer the LEDs are “on,” the more power the circuit is required to dissipate. If the power exceeds a threshold, the LEDs and associated circuitry may be damaged or fail. Preferably, the microprocessor monitors the cumulative “on” time of the LEDs and removes the input to the “AND” gate if excess power dissipation is detected. By removing the supervisory control signal from the “AND” gate, the positive output signal from the gate will also cease thereby turning “off” the electronic switch. When the electronic switch is “off,” the LEDs are off as well.

While the LEDs are not illuminated, the monitoring system continues to determine the average power dissipation. Since the LEDs are not receiving current, the average power will decrease over time. Once the average power dissipation for the sliding time window drops below a threshold, a positive supervisory control signal is again applied to the “AND” gate, which, in turn, switches the electronic switch “on” and illuminates the LEDs if the user input signal is also positive.

If the user input signal, preferably from an associated camera, is still present, the control system will preferably control the electronic switch through pulse width modulation (PWM) to maintain the power dissipation of the circuit at a satisfactory level. If the average power levels dissipated by the circuit never exceed the threshold, the control circuit will continue to drive the LEDs at maximum power during illumination and PWM will not be required.

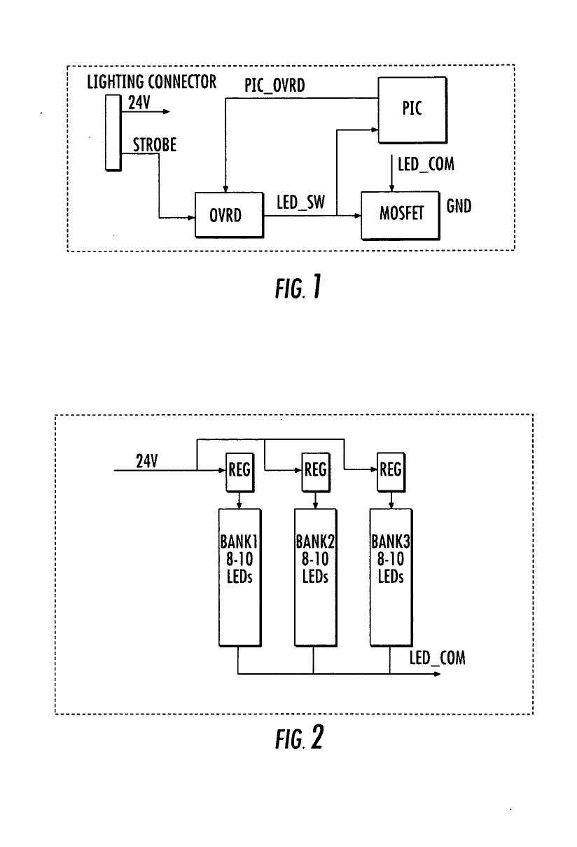

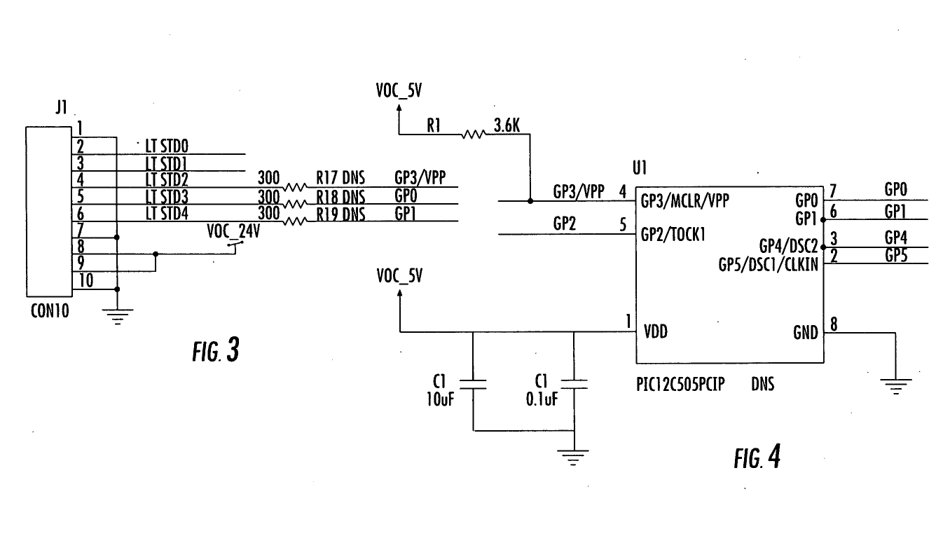

Details of a specific embodiment will now be described. In this regard, FIG. 1 shows a first portion 10a of an illumination apparatus 10 constructed in accordance with the present invention. Portion 10a includes a connector 12 for power (e.g., 24 volts) and the external strobe signal (STROBE) produced by the machine vision camera. A switch 14 (here in the form of a MOSFET) for turning the LEDs on/off is also provided. Switch 14 can turn on the connection from LED_COM to GND (ground), which will allow current to flow through the LEDs. (As can be seen in FIG. 2, LED_COM is the low side of the LED array.) Microprocessor 16 (labeled “PIC”) performs supervisory control of the LED illumination time (which is indicative of power dissipation). Microprocessor 16 can monitor the amount of time that the LEDs are on, and then overrides the user input to limit the average power consumption of the LEDs by pulse width modulating (PWM) the LEDs.

FIG. 1 also shows an override switch (OVRD) 18. Override switch 18 is placed before the LED_SW goes into switch 14. A line from microprocessor 16 to switch 18 provides the supervisory control signal. This allows microprocessor 16 to override (turn off) the LED_SW signal, preventing switch 14 (and thus the LEDs) from turning on.

FIG. 2 shows another portion 10b of illumination apparatus 10. In this case, a plurality of LED banks 20a, 20b and 20c (also labeled BANK1, BANK2, BANK3) are provided. While this figure shows three duplicated banks, in general there can be one or more banks. A respective current control (REG) 22a, 22b and 22c maintains constant current through the LEDs in each bank while they are on. Each current control 22a, 22b and 22c takes an input voltage and regulates the current through the LEDs. As the voltage varies on the input, the light intensity output of the LEDs remains substantially constant.

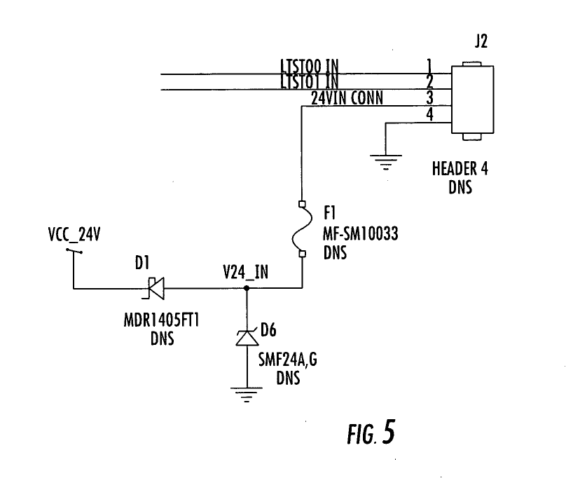

FIGS. 3-8 detail a particular implementation of the circuitry within illumination apparatus 10 shown in FIGS. 1 and 2. The circuitry will typically be located on one or more circuit boards. Referring first to FIG. 3, the external connector 12 is shown with power input (VC_{—}24V) and strobe input(s) (LT_STRB0-4). Extra inputs are provided in this implementation, so that the “spare” pins could be used during testing, or to send the program to microprocessor 16 when it powers up. In another embodiment, a heater element may be provided on the lighting board if intended for use in cold environments such as freezers. In such an embodiment, one of the spare LT_STRB pins may be used as the control signal for the heater.

In the embodiment of FIG. 3, the connector will generally be used when the light is mounted inside the camera and has direct connection to the main vision processor. This allows the vision processor to download initial programming to the microprocessor 16.

When assembled as an external lighting source, the connector in FIG. 4 may be used. Protection diodes 32 and 34 and fuse 36 could be provided in case the user miswires the light to power. In this implementation, two strobe inputs are provided.

FIG. 5 shows an embodiment of the supervisory microprocessor 16. A program running on microprocessor 16 monitors the amount of time (power) that the LEDs are on at full strength. Once the power consumption (based on time) reaches a limit, microprocessor 16 initiates protection and modulates, such as pulse width modulates (PWM), the override output to limit the average continuous power in the LEDs to a desired level.

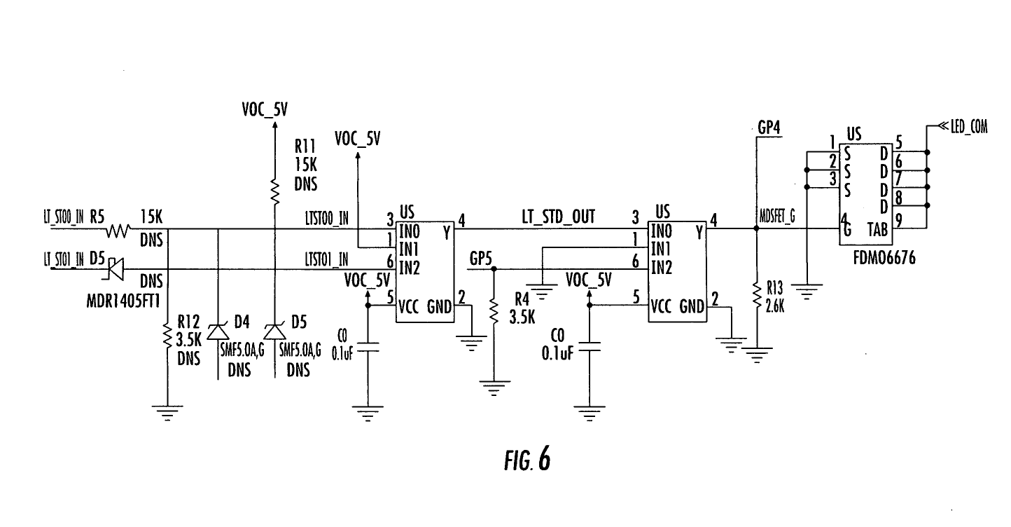

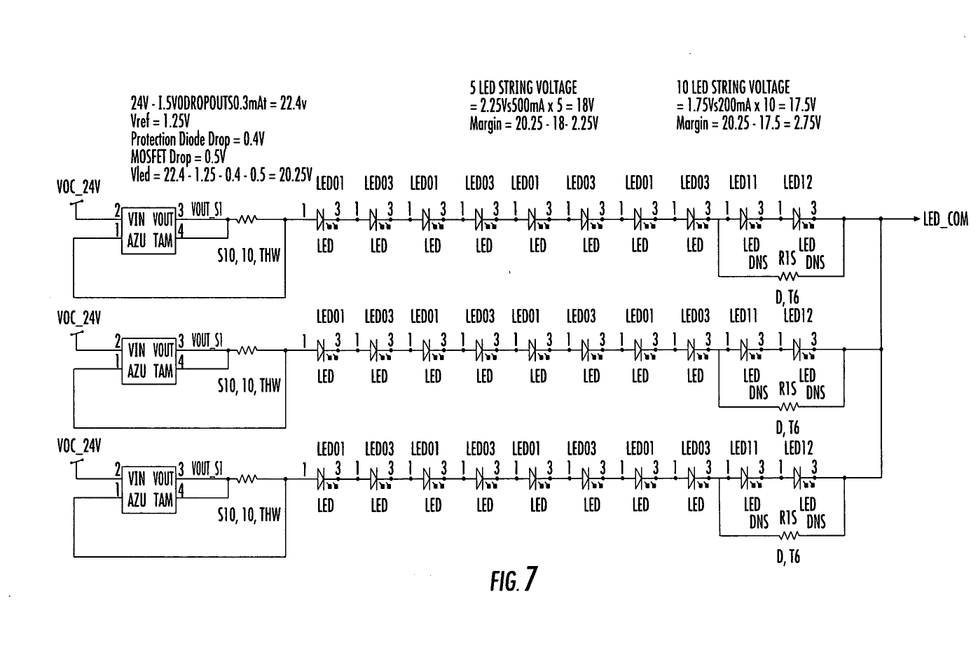

Looking from left to right, FIG. 6 shows input protection diodes (generally 40) in case the user miswires the strobe input signals. In this implementation, there are two signals available for the user, one that is active high, meaning that the user applies a positive voltage to turn the strobe light on, and one that is active low, meaning the user provides a low voltage (0 volts) to turn the light on. Thus, a logic OR chip 42 is provided to receive the two inputs. If chip 42 receives either input signal, chip 42 outputs an “on” signal. In this regard, the override switch 18 is connected to receive the output of chip 42. In particular, switch 18 looks at the output of the chip 42. In addition, the override signal from microprocessor 16 will provide an “on” signal to switch 18 if the override is off and one of the two user inputs is “on.” Switch 14, which, when its input (from override switch 18) is on, will connect the LEDs (LED_COM) to ground (GND), allowing current to flow through the LEDs.

FIG. 7 shows the three banks of LEDs 20a-c and their associated current controllers 22a-c. Current controllers (REG) 22a-c each take an input voltage and allow a fixed amount of current to flow through it. In this implementation, a respective resistor 50a-c is used to provide feedback to the controller chip 52a-c to maintain the fixed current. The resistor and controller are both part of the overall current controller 22a-c.

A series of LEDs forming the bank are also shown. The number of LEDs depends on the specific color and brand of LED used, and minimum expected power voltage (typically 24 volts). Red LEDs typically drop about 1.7 volts per LED, while white LEDs may drop about 2.5 volts. In this implementation, the last two LEDs can be bypassed to account for the large variation in voltage for different lighting configurations. The current controller then accounts for minor variation, since it regulates the current, as long as the combined voltage across the series of LEDs is less than the input voltage.

FIG. 8 shows a voltage regulator 60 that may be used to reduce the input voltage for use by microprocessor 16. This may be needed in some implementations, but it is also contemplated that the microprocessor may be able to self regulate its input voltage in some embodiments.

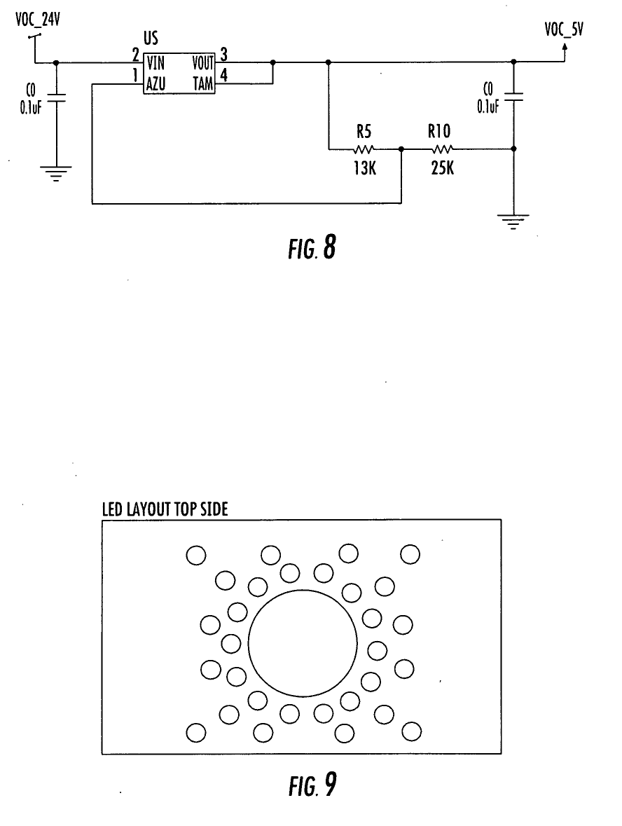

FIG. 9 shows the relative placement of the LEDs on the printed circuit board (PCB) 62 for this particular implementation.

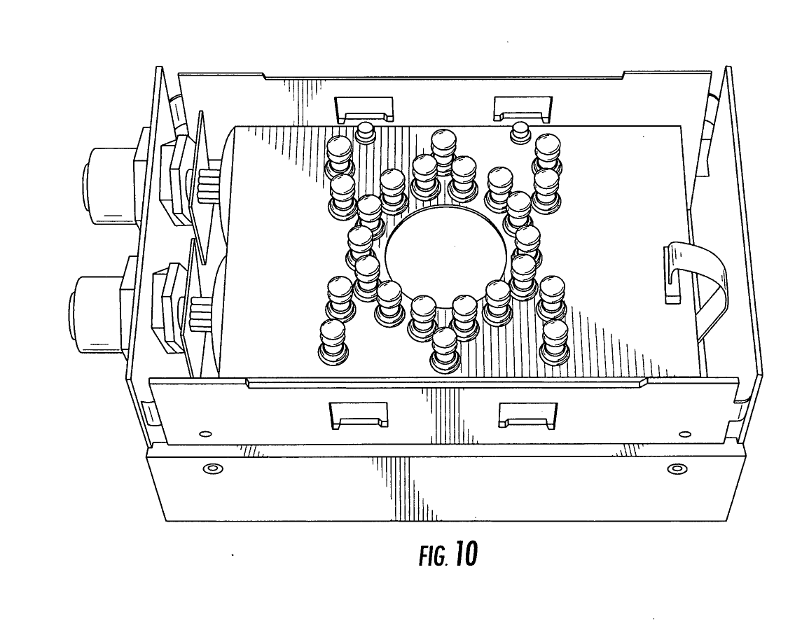

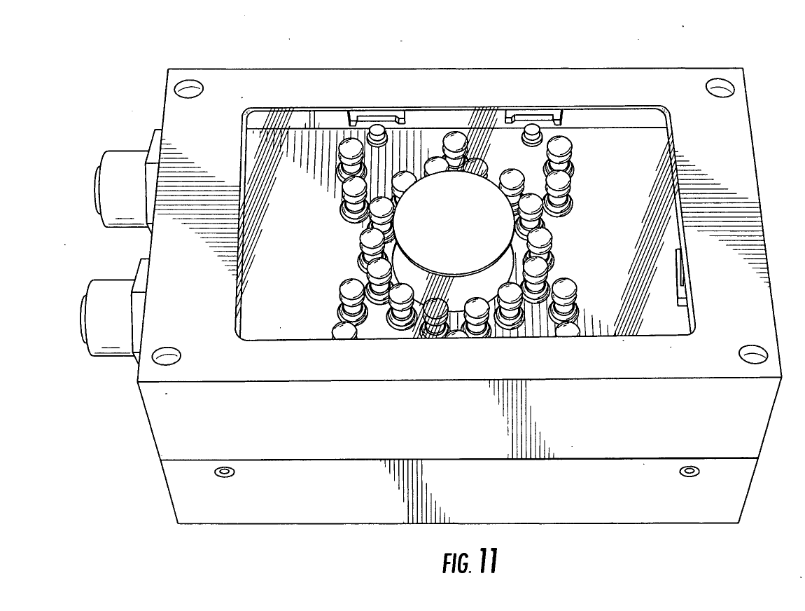

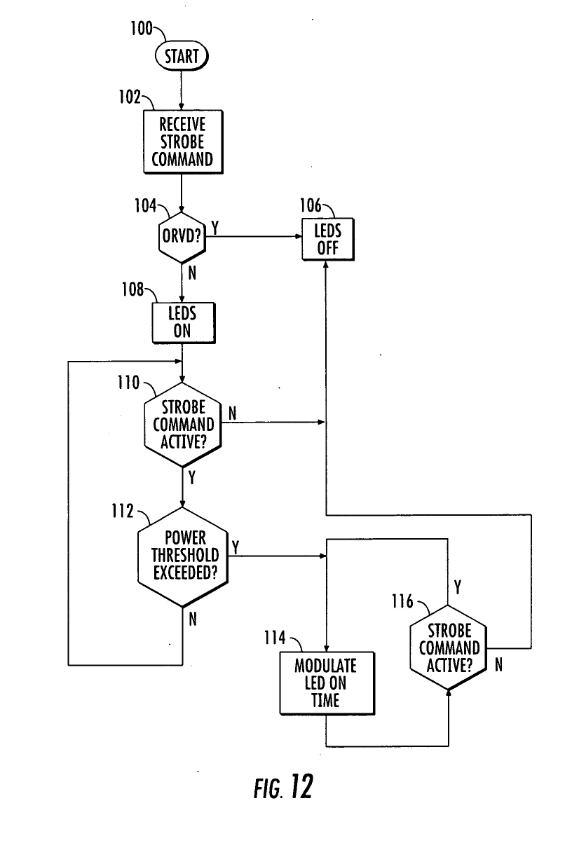

FIGS. 10 and 11 are of a particular implementation, in a ring light configuration, designed to be mounted inside the camera. In general, the apparatus can be in its own case with an external connector to provide the user the ability to connect it to other cameras.

FIG. 12 illustrates exemplary methodology that may performed in the illumination apparatus 10 by the programming implemented at microprocessor 16. The process starts at 100. If a strobe command is received from the camera (as indicated at 102), an override (as indicated at 104) causes the LEDs to remain off (as indicated at 106). If no override, the LEDs will turn on (as indicated at 108). If the strobe command from the camera subsequently stops (as indicated at 110), the LEDs will turn off (106). Otherwise, microprocessor 16 monitors whether the “on time” has exceeded the time window (as indicated at 112), which is indicative of power dissipation. If the time window has been exceeded, the on time of the LEDs is modulated (as indicated at 114) so that power dissipation remains below a desired threshold. This modulation will continue so long as the strobe command remains active. If the strobe command stops (as indicated at 116), then the LEDs will turn off (106).

In a preferred embodiment, one feature of the algorithm/software running on the microprocessor 16 is that when the system is powered up, if the input is “permanently on,” then the apparatus will power up in a mode to continuously pulse width modulate (PWM) the LEDs, effectively acting like a backlight. Then if the input is turned “off,” the light switches back to “strobe” mode, whereby turning the input on will cause the light to output a high intensity pulse, lasting the duration of the input, possibly switching back to PWM mode to prevent burning up the LEDs (if user tries to pulse LEDs for too long, consuming too much power).

Instead of using PWM to cap the power dissipation after the initial high intensity pulse, the system could also direct the regulator to vary power dissipation by reducing the controlled current from its preset maximum to a reduced current, achieving a similar effect as PWM. Another option is to have more than one current controller per LED bank, each with potentially different current settings, and the supervisor can turn on any combination of REGs to get a variable current after the main high intensity pulse.

Various LED driver circuits and control systems are shown in U.S. Pat. Nos. 7,286,123, 6,933,707, 6,160,354 and U.S. Published App. Nos. 20070132692 and 20070097044, each of which is incorporated by reference in its entirety.

While preferred embodiments of the invention have been shown and described, modifications and variations may be made thereto by those of ordinary skill in the art without departing from the spirit and scope of the present invention. For example, one skilled in the art will appreciate that the described circuitry can be implemented as various combinations of discrete components, integrated circuits including application specific integrated circuits, firmware, hardware and software. In addition, it should be understood that aspects of the various embodiments may be interchanged both in whole or in part. Furthermore, those of ordinary skill in the art will appreciate that the foregoing description is by way of example only, and is not intended to be limitative of the invention as further described in the appended claims.

What is claimed is:

1. An illumination apparatus comprising:
at least one light source;
control circuitry operative to receive an illumination command signal and selectively cause application of power to said light source in response thereto, said circuitry including:
(a) an electronic switch connected in circuit with said light source; and
(b) override circuitry connected to control operation of said electronic switch so as to cause flow of current through said light source upon receipt of said illumination command signal in a variable manner so as to limit power dissipation.

2. An illumination apparatus as set forth in claim 1, wherein said at least one light source is at least one LED.

3. An illumination apparatus as set forth in claim 2, wherein said at least one LED comprises a plurality of LEDs connected arranged in series to form a bank of LEDs.

4. An illumination apparatus as set forth in claim 3, further comprising a current control circuit associated with said bank of LEDs to provide a substantially constant current thereto despite fluctuations in source voltage.

5. An illumination apparatus as set forth in claim 2, wherein said at least one LED comprises a plurality of banks of LEDs, each said bank having a plurality of LEDs connected in series.

6. An illumination apparatus as set forth in claim 1, wherein said override circuitry is adapted to modulate application of power to said light source to maintain power dissipation under a threshold.

7. An illumination apparatus as set forth in claim 6, wherein said override circuitry is operative to allow application of full power to said light source for a predetermined period of time and thereafter modulate application of power to said light source.

8. An illumination apparatus as set forth in claim 6, wherein said override circuitry modulates application of power to said light source by turning power on and off using a pulse width modulation technique.

9. An illumination apparatus as set forth in claim 1, wherein said override circuitry comprises:
a microprocessor providing a supervisory command signal as an output; and
an override switch connected to receive as inputs said illumination command signal and said supervisory command signal and, based on said inputs, controlling said electronic switch.

10. An illumination apparatus as set forth in claim 9, further comprising an input switch having high and low level inputs, said input switch operative to provide said illumination command signal to said override switch if either of said high and low inputs indicates a command signal.

11. An illumination apparatus as set forth in claim 1, wherein said control circuitry is adapted to receive either one of a high level illumination command signal and a low level illumination command signal.

12. An illumination control apparatus as set forth in claim 1, wherein said electronic switch is a transistor.

13. An illumination control apparatus as set forth in claim 10, wherein said transistor is a MOSFET.

14. A method of controlling application of power to a camera strobe which will remain on for definite period of time, said method comprising steps of:
(a) in response to a strobe command signal, applying power to at least one LED in order to illuminate said at least one LED; and
(b) if said strobe command signal exceeds a selected period of time, varying application of power to said at least one LED in order to limit power dissipation.

15. A method as set forth in claim 14, wherein application of power to said at least one LED is varied in step (b) by modulation.

16. A method as set forth in claim 15, wherein application of power to said at least one LED is varied in step (b) by pulse width modulation.

17. A method as set forth in claim 16, wherein said pulse width modulation is operative to control on time of said at least one LED during a sliding time window.

18. A light source for use with a machine vision camera, said light source comprising:
a plurality of LEDs connected in series to form a bank of LEDs; and
a current control circuit associated with said bank of LEDs to provide a substantially constant current thereto despite fluctuations in source voltage.

19. A light source as set forth in claim 18, wherein said plurality of LEDs comprise at least eight LEDs connected in series.
